(19) United States
(12) Patent Application Publication
(10) Pub. No.: US 2021/0135825 A1
(43) Pub. Date: May 6, 2021

(54) METHODS AND APPARATUSES FOR NON-ORTHOGONAL MULTIPLE ACCESS

(71) Applicant: IDAC HOLDINGS, INC., Wilmigton, DE (US)

(72) Inventors: Kyle Jung-Lin Pan, Saint James, NY (US); Fengjun Xi, San Diego, CA (US)

(73) Assignee: IDAC HOLDINGS, INC., Wilmington, DE (US)

(21) Appl. No.: 16/962,942

(22) PCT Filed: Jan. 18, 2019
(86) PCT No.: PCT/US2019/014232

§ 371 Date: Jul. 17, 2020

Related U.S. Application Data
(60) Provisional application No. 62/619,538, filed on Jan. 19, 2018.

(51) Int. Cl. H04L 5/00; H04W 72/04

(52) U.S. Cl. CPC H04L 5/0053; H04L 5/0005; H04W 72/042; H04W 72/0413; H04L 5/0037

(57) ABSTRACT

Methods and apparatuses are described herein for Orthogonal Multiple Access (OMA) and Non-Orthogonal Multiple Access (NOMA) in a wireless transmit/receive unit (WTRU). A WTRU may determine a first resource associated with first transmission and a second resource associated with second transmission for uplink (UL) NOMA. The WTRU may generate control information including selection information of the second resource. The WTRU may transmit the control information using the UL NOMA on the first resource. The WTRU may then receive one or more indicators indicating whether the second transmission uses OMA or NOMA. The one or more indicators may comprise a discontinue NOMA transmission indicator (DTI) and a NOMA type transmission indicator (NMI). If the DTI indicates the OMA, the WTRU transmit data on the second resource using the OMA. If the DTI indicates the NOMA, the WTRU transmit, based on the NMI, data on the second resource using the UL NOMA.

### CROSS REFERENCE TO RELATED APPLICATIONS

This application claims benefit of U.S. Provisional Application No. 62/619,538, filed Jan. 19, 2018, the contents of which are hereby incorporated by reference herein.

### BACKGROUND

Similar to Long Term Evolution (LTE), basic multiple access schemes for New Radio (NR) is orthogonal for both downlink and uplink data transmissions, meaning that time and frequency physical resources of different users may not be overlapped. However, Non-Orthogonal Multiple Access (NOMA) schemes recently gained wide interest because of its significant benefit in uplink (UL) link-level sum throughput, overloading capability, and system capacity enhancement in terms of supported packet arrival rate at given system outage. Thus, a system that can support both NOMA and Orthogonal Multiple Access (OMA) can provide enhanced system performance. However, in order to cope with both NOMA and OMA, channel sharing and access may need to be considered such that NOMA and OMA can operate jointly and efficiently in the same system. Thus, methods and apparatuses that enable efficient NOMA and OMA transmission in a wireless system are needed.

### SUMMARY

Methods and apparatuses are described herein for Orthogonal Multiple Access (OMA) and Non-Orthogonal Multiple Access (NOMA) in a wireless transmit/receive unit (WTRU). For example, a WTRU may receive, from a base station (BS), a NOMA resource configuration that includes time and frequency resources for the uplink (UL) NOMA. The WTRU may then determine a first resource and a second resource for UL NOMA. The first resource may be associated with first or current transmission and the second resource may be associated with second or subsequent transmission. The WTRU may generate control information that includes selection information of the second resource. The selection information may include a location of the second resource in the NOMA resource configuration. The WTRU may transmit, to a base station (BS), the control information using the UL NOMA on the first resource as the first transmission. After transmitting the control information, the WTRU may receive, from the BS, one or more indicators indicating whether the second transmission uses NOMA or OMA on the second resource. The one or more indicators may comprise a discontinue NOMA transmission indicator (DTI) and a NOMA type transmission indicator (NMI). The NMI may indicate a type of NOMA transmission based on a multiple access signature. If the DTI indicates to use the OMA, the WTRU may transmit data on the second resource using the OMA as the second transmission. If the DTI indicates to use the NOMA, the WTRU may transmit, based on the NMI, data on the second resource using the UL NOMA as the second transmission.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 10 is a system diagram illustrating an example radio access network (RAN) and an example core network (CN) that may be used within the communications system illustrated in FIG. 1A according to an embodiment;

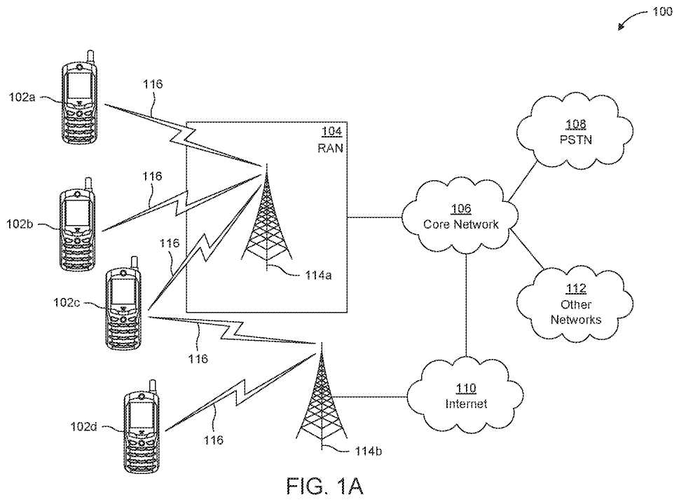

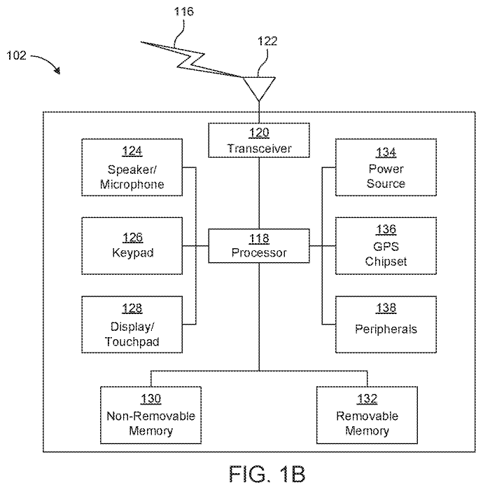

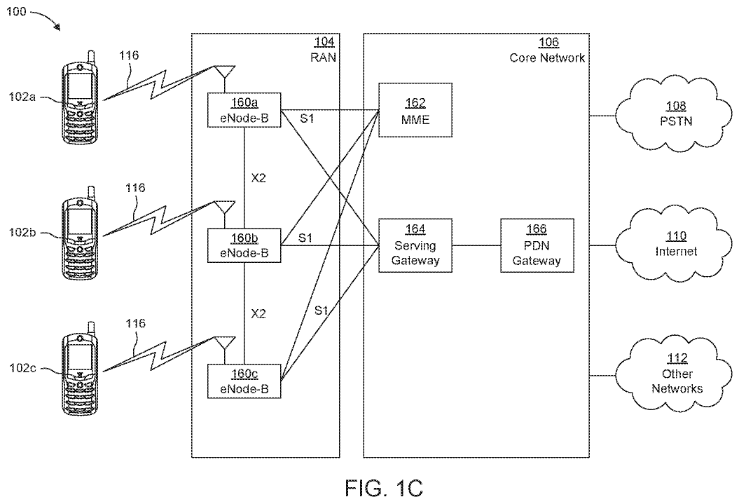

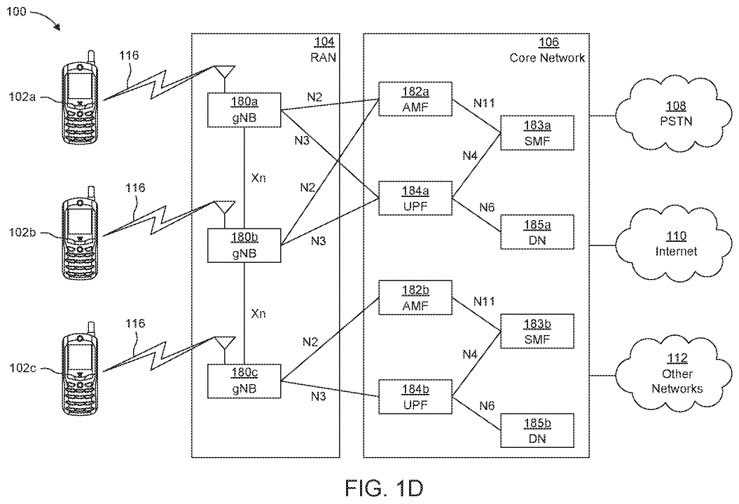

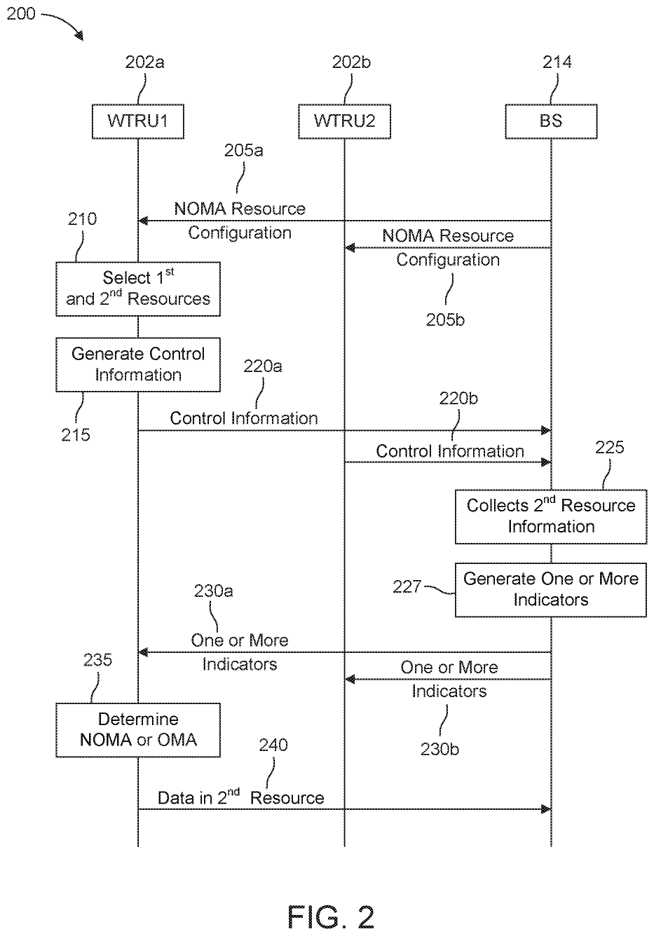

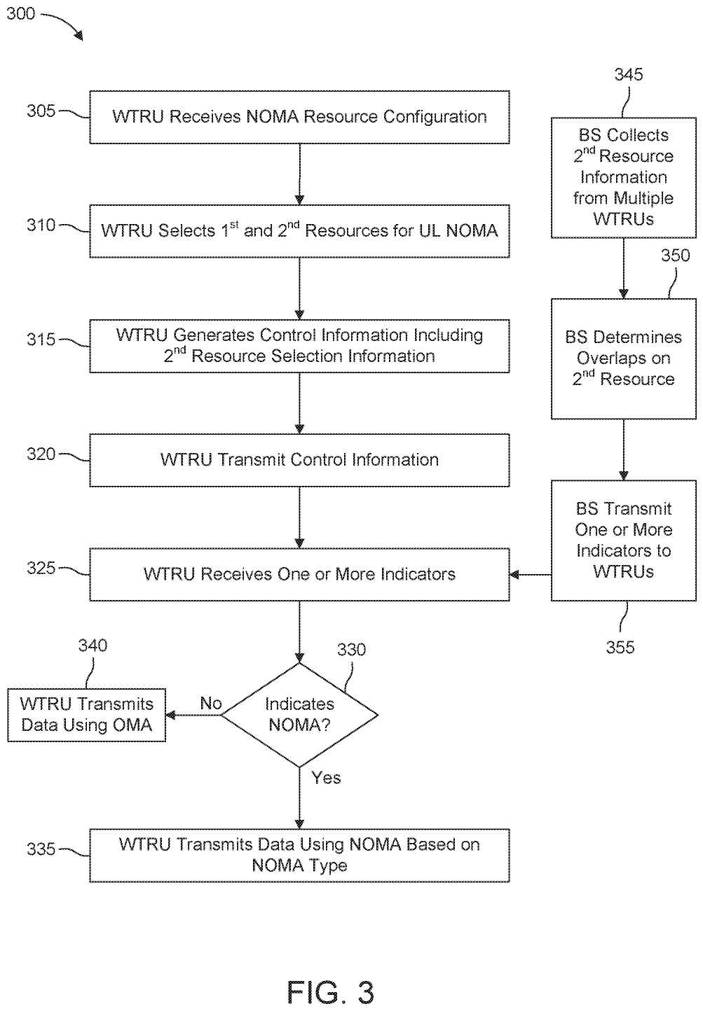

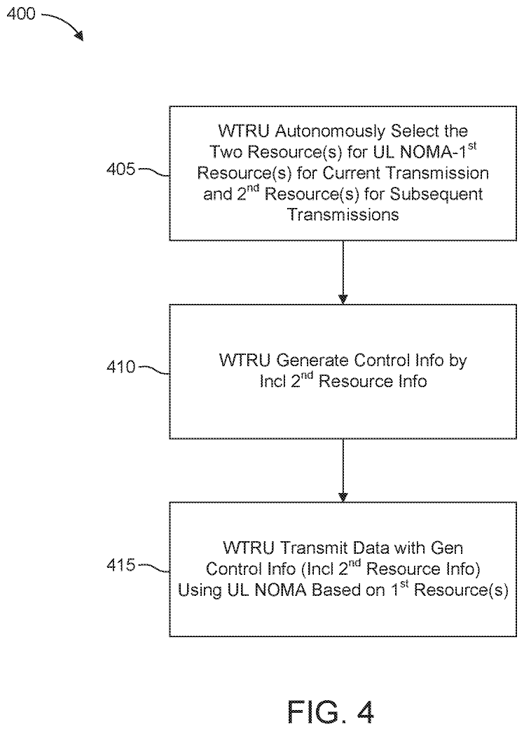

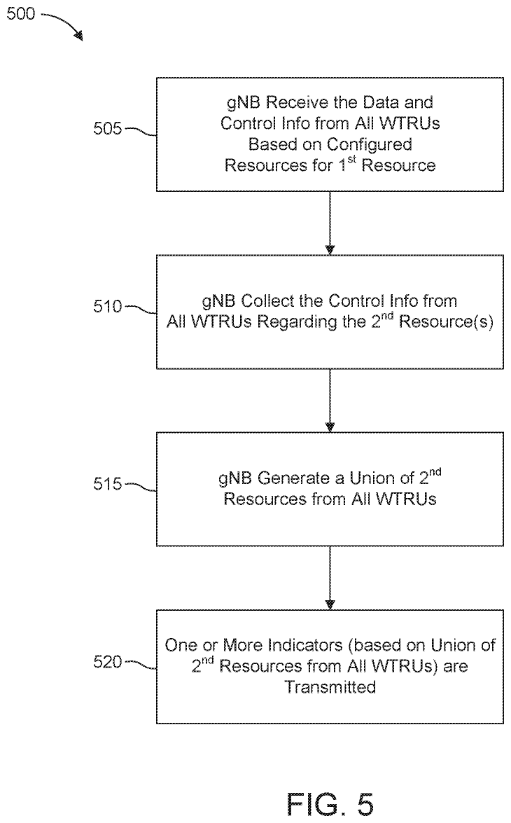

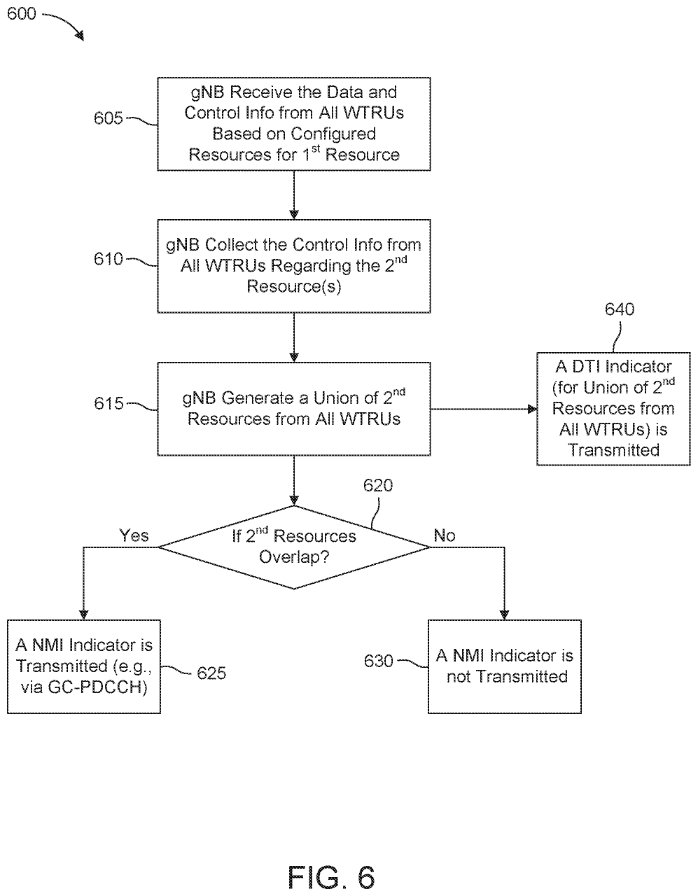

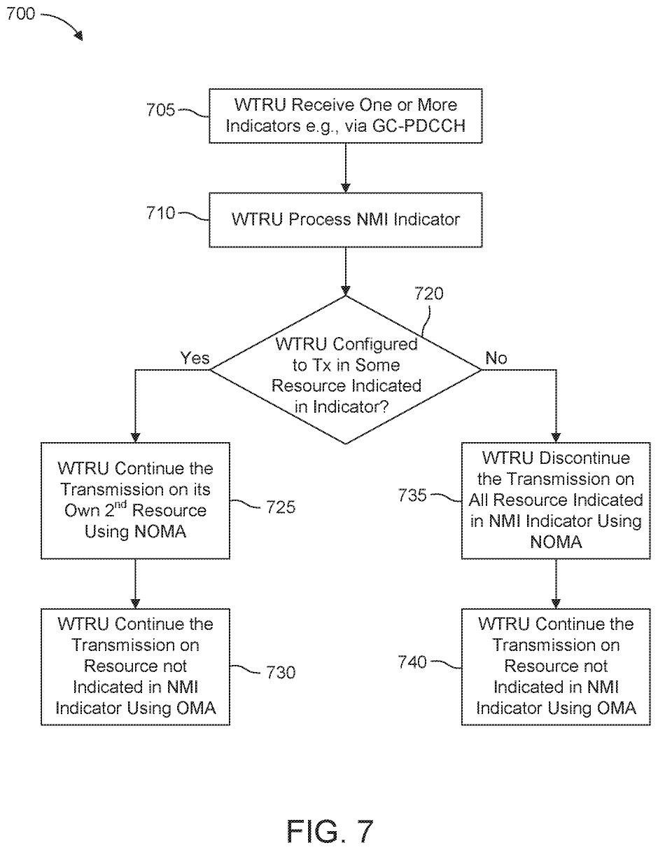

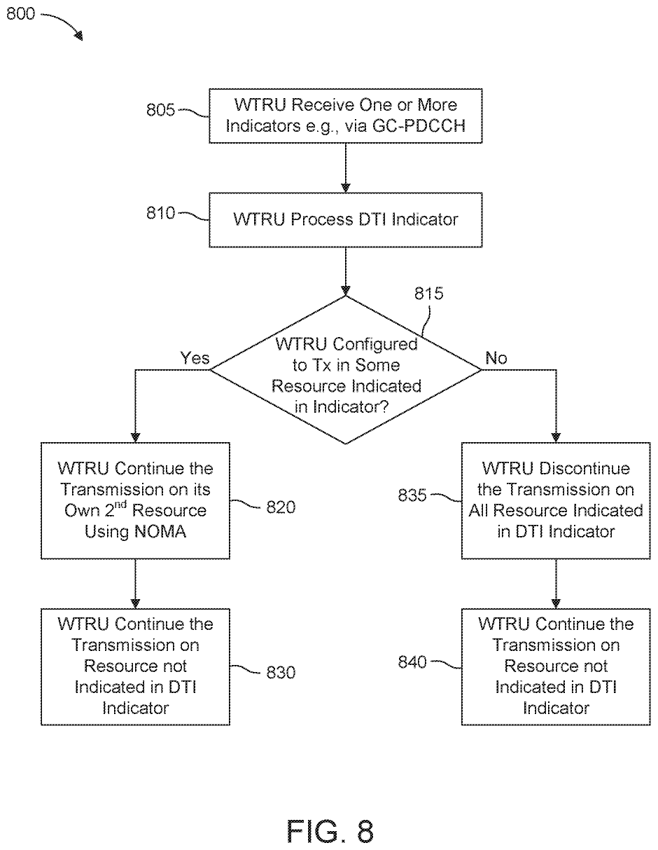

FIG. 1D is a system diagram illustrating a further example RAN and a further example CN that may be used within the communications system illustrated in FIG. 1A according to an embodiment;

FIG. 2 is a diagram illustrating an example signaling procedure for Non-orthogonal Multiple Access (NOMA) and/or Orthogonal Multiple Access (OMA) transmission in a wireless network;

FIG. 3 is a diagram illustrating an example overall procedure for NOMA and/or OMA transmission;

FIG. 4 is a diagram illustrating an example WTRU transmit processing for NOMA;

FIG. 5 is a diagram illustrating an example gNB processing for NOMA;

FIG. 6 is a diagram illustrating an example gNB processing for hybrid NOMA/OMA;

FIG. 7 is a diagram illustrating an example WTRU receive processing for NOMA;

FIG. 8 is a diagram illustrating an another example WTRU receive processing for NOMA;

FIG. 9 is a diagram illustrating an example WTRU receives processing for hybrid NOMA/OMA;

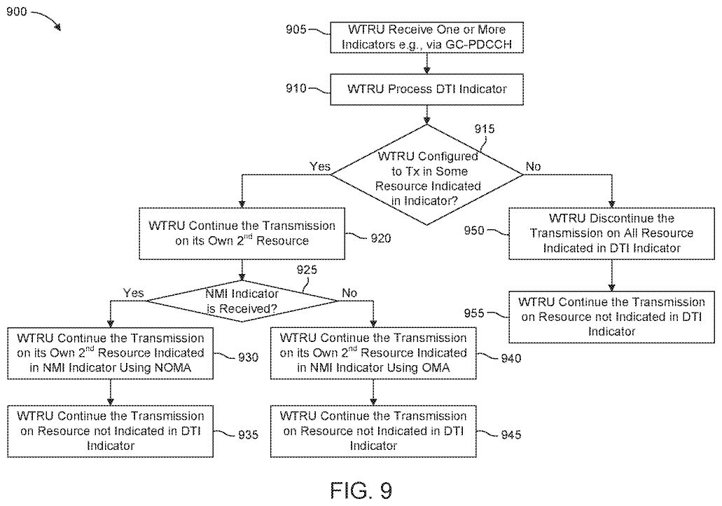

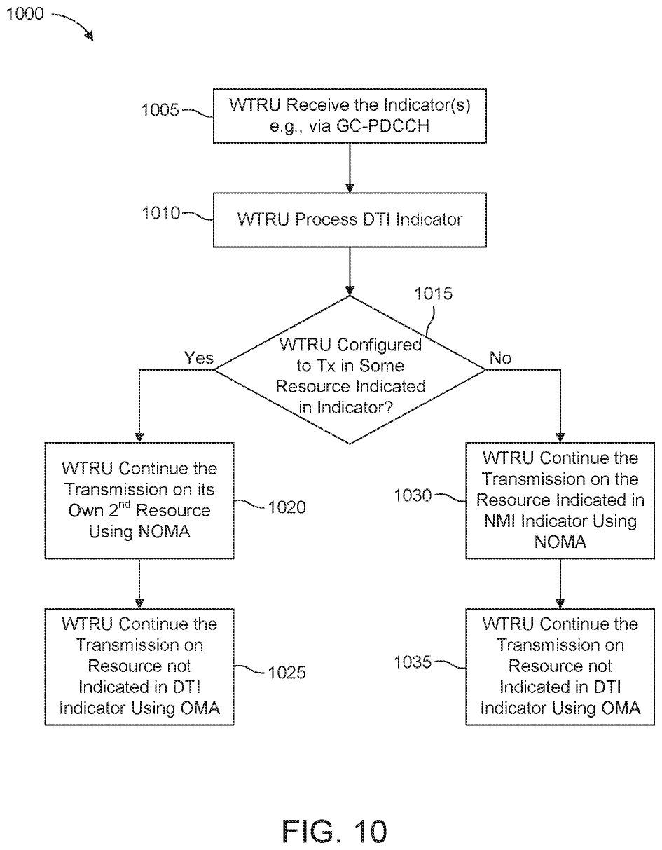

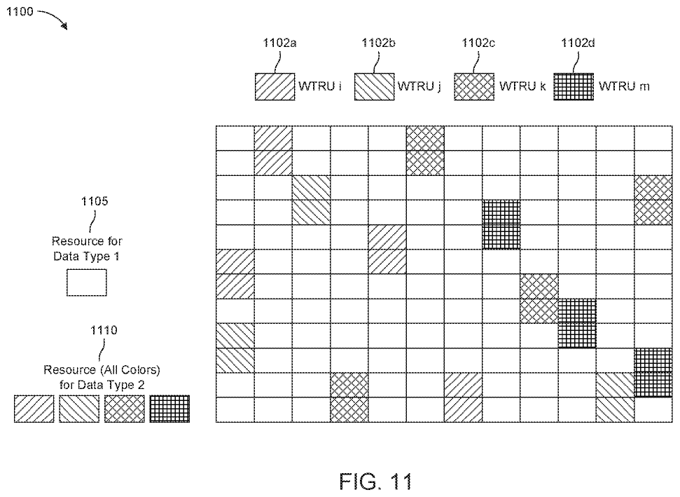

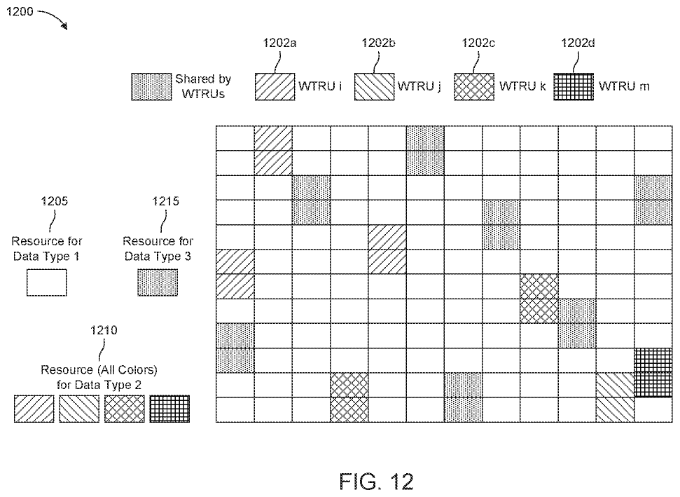

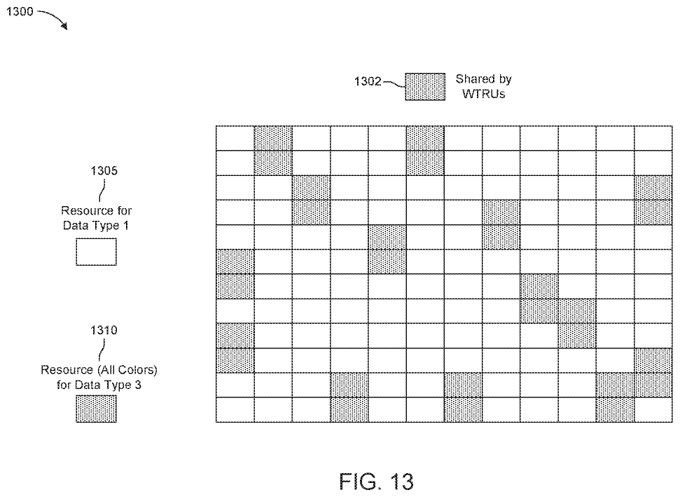

FIG. 10 is a diagram illustrating an example WTRU receive processing for NOMA and/or OMA;

FIG. 11 is a diagram illustrating an example Orthogonal Multiple Access (OMA);

FIG. 12 is a diagram illustrating an example joint Orthogonal Multiple Access (OMA) and Non-orthogonal Multiple Access NOMA); and

FIG. 13 is a diagram illustrating an example Non-orthogonal Multiple Access (NOMA).

### DETAILED DESCRIPTION

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Based on the general requirements set out by International Telecommunication Union Radiocommunication (ITU-R), Next Generation Mobile Networks (NGMN) and 3^{rd} Generation Partnership Project (3GPP), a broad classification of the use cases for emerging 5G systems can be depicted as follows: Enhanced Mobile Broadband (eMBB), Massive Machine Type Communications (mMTC) and Ultra Reliable and Low latency Communications (URLLC). Different use cases may focus on different requirements such as higher data rate, higher spectrum efficiency, low power and higher energy efficiency, lower latency and higher reliability. A wide range of spectrum bands ranging from 700 MHz to 80 GHz are being considered for a variety of deployment scenarios.

It is well known that as the carrier frequency increases, the severe path loss becomes a crucial limitation to guarantee the sufficient coverage are. Transmission in millimeter wave systems could additionally suffer from non-line-of-sight losses, for example, diffraction loss, penetration loss, Oxygen absorption loss, foliage loss, etc. During initial access, a base station and a WTRU need to overcome these high path losses and discover each other. Utilizing dozens or even hundreds of antenna elements to generated beam formed signal may be an effective way to compensate the severe path loss by providing significant beam forming gain. Beamforming techniques may include digital, analogue and hybrid beamforming.

Similar to Long Term Evolution (LTE), the basic multiple access scheme for NR is orthogonal for both downlink and uplink data transmissions, meaning that time and frequency physical resources of different users are not overlapped. On the other hand, non-orthogonal multiple-access (NOMA) schemes recently gained wide interest because of its significant benefit in terms of UL link-level sum throughput and overloading capability, as well as system capacity enhancement in terms of supported packet arrival rate at given system outage.

For NOMA, there may be interference between transmissions using overlapping resources. As the system load increases, this non-orthogonal characteristic may be more pronounced. To combat the interference between non-orthogonal transmissions, various NOMA schemes with various multiple access signatures may be employed to improve the performance and ease the burden of advanced receivers. Specifically, when multiple users (or WTRUs) are transmitting data in the overlapping resources using NOMA, multiple access signatures can be used to distinguish the users (or WTRUs) from the non-orthogonal transmissions in the overlapping resources. Examples of such signatures may include, but are not limited to, spreading (e.g., linear or non-linear, with or without sparseness), fast code, low code rate, and interleaving/scrambling. These signatures may be also used to distinguish multiple users (or WTRUs) in NOMA. Examples of such NOMA schemes may include, but are not limited to, Interleaver Division Multiple Access (IDMA), Interleaver Grid Multiple Access (IGMA), Low Code Rate Spreading (LCRS), Multi-User Shared Access (MUSA), Non-orthogonal Coded Multiple Access (NCMA), Non-Orthogonal Coded Access (NOCA), Group Orthogonal Coded Access (GOCA), Resource Spread Multiple Access (RSMA), Sparse Code Multiple Access (SCMA), and Pattern-Division Multiple Access (PDMA). The IDMA and IGMA may be based on interleaver/scrambling. The LCRS may be based on low code rate. The MUSA, NCMA, GOCA, and RSMA may be based on spreading. The SCMA and PDMA may be based on sparse-based spreading.

Non-orthogonal transmission can be applied to both grant-based and grant-free transmission. The benefits of NOMA, particularly when enabling grant-free transmission, may encompass a variety of use cases or embodiments, including eMBB, URLLC, mMTC, or the like.

Non-orthogonal multiple access (NOMA) may be used for channel access in addition to orthogonal multiple access (OMA). A device or system that can support both NOMA and OMA can provide enhanced system performance. However, in order to cope with both NOMA and OMA, the channel sharing and access may need to be considered such that NOMA and OMA can operate jointly and efficiently in the same system.

As described above, NOMA and OMA may be used for WTRU transmission and channel access. For example, WTRUs performing URLLC may use OMA. WTRUs performing eMBB may use OMA and NOMA. Among the WTRUs performing URLLC, NOMA may also be used. Among the WTRUs performing mixed URLLC and eMBB, NOMA may also be used. WTRUs performing mMTC may use NOMA. Some resources may be used for OMA and other resources may be used for NOMA. The partitions between OMA and NOMA resources may be configured.

To achieve efficient multiple access and resource utilization for NOMA and enable joint NOMA and OMA operations, a hybrid NOMA and OMA scheme may be described herein. In the hybrid NOMA and OMA scheme, one or more indicators such as a NOMA indicator (NMI) may be used to indicate which resources may be used for NOMA and/or a type of NOMA transmission. The remaining resources within NOMA resource partition (i.e. not indicated in NOMA indicator) may be used for OMA. In addition, a discontinuous transmission indication (DTI) may be used to prioritize the data transmission at a WTRU. When the WTRU detects or receives a DTI, the WTRU may discontinue the transmission in the resources indicated in the DTI. The terms discontinuous transmission indication and discontinuous NOMA transmission indication may be interchangeably used throughout this disclosure. Furthermore, when a WTRU receives both a NMI and a DTI, the NMI may override the DTI.

A NOMA indicator (NMI) and/or a discontinuous transmission indication (DTI) may be used individually or jointly with or without the other indicator. A NOMA indicator (NMI) may be used to indicate the resources within the resources indicated in a discontinuous transmission indication (DTI). Alternatively or additionally, a NOMA indicator (NMI) may also be used to indicate the resources outside the resources indicated in a discontinuous transmission indication (DTI).

The following examples may be considered for NOMA or hybrid NOMA/OMA. For example, for URLLC only scenarios, all WTRUs performing URLLC may use NOMA. In this case, a NMI may indicate the type of NOMA transmission. In another URLLC only scenario, some WTRUs performing URLLC may use OMA and other WTURs performing URLLC may use NOMA depending on overlapping resources. For URLLC and eMBB scenarios, WTRUs may use NOMA for URLLC and/or eMBB. For mMTC-only scenarios, WTRUs may use NOMA.

In some embodiments, WTRUs performing URLLC may or may not use NOMA with eMBB. A DTI indicator may be used to indicate UL URLLC resources. Additionally or alternatively, a NMI indicator may be used to indicate which resources within indicated UL URLLC resources use NOMA or OMA. A NOMA indicator (NMI) and/or a discontinuous transmission indication (DTI) may be used for uplink, downlink, or both uplink and downlink.

As used herein, the term resource (or radio resource) may refer to one or more elements from the time, frequency, and spatial domain. Examples of resources may include, but are not limited to resource blocks (RB), resource elements (RE), frequencies, radio frames, subframes, symbols, subcarriers, beam patterns, and antenna arrangements.

WTRU transmit processing of hybrid NOMA/OMA is described herein. A WTRU may autonomously select the resource for UL NOMA transmission. A WTRU may autonomously select the resource from a set of NOMA resources or resource partition that may be configured to the WTRU. A WTRU may autonomously select a signature for transmission on the selected resource. The WTRU may autonomously select a signature from a pool of signatures that have not been assigned by a grant-based NOMA. A WTRU may receive a MA signature indication (MASI) that indicates the allowable signatures that the WTRU may select from. The MASI may be indicated to WTRUs via a downlink control channel, for example, the common control channel or group common PDCCH (GC-PDCCH). The MASI may also be indicated to WTRUs via system information such as remaining minimum system information (RMSI), NR-PBCH, and other system information (OSI).

FIG. 2 illustrates an example signaling procedure 200 for Non-Orthogonal Multiple Access (NOMA) and/or Orthogonal Multiple Access (OMA) transmission, which may be used in combination with any of other embodiments described herein. As illustrated in FIG. 2, a wireless network may comprise multiple WTRUs (e.g., WTRU1 202a and WTRU2 202b) and a base station (BS) 214 (e.g., gNB). The WTRU1 202a and WTRU2 202b may receive NOMA resource configuration from the BS 214 at steps 205a, 205b. The NOMA resource configuration may include information about resources in which the NOMA may operate. Examples of NOMA resource configuration may include, but are not limited to, a resource pool, time, and frequency for NOMA transmission. While the WTRUs 202a, 202b are in connected mode, the NOMA resource configuration may be received via radio resource control (RRC) signaling. While the WTRUs 202a, 202b are in idle mode, the NOMA resource configuration may be received via system information broadcasting (e.g., system information block (SIB)).

Once the NOMA resource configuration is received at steps 205a, 205b, each of the WTRUs 202a, 202b may autonomously select multiple resources for UL NOMA. For example, at step 210, each of the WTRUs 202a, 202b may autonomously select a first resource and a second resource for UL NOMA. The first resource may be used for current transmission (or first transmission) and the second resource may be used for subsequent transmission (or second transmission). Although it is not illustrated, each of the WTRUs 202a, 202b may select more than two resources for respective subsequent transmissions. The multiple resources selected by each of the WTRUs 202a, 202b may be determined based on criteria such as service types, resource partitions, priority, latency or the like. For example, the WTRUs 202a, 202b may consider the service types that require high latency (e.g., eMBB) or low latency (e.g., URLLC) to determine the resources. Specifically, the first resource may be selected for the low latency traffics (e.g., URLLC) and the second resource may be selected for the high latency traffic (e.g., eMBB). In this case, it is more likely that the high latency traffics (e.g., eMBB) may be transmitted in the second resource using NOMA assuming that there are many WTRUs that also select their second resources for high latency traffics (e.g., eMBB). The WTRUs 202a, 202b may consider the resource partitions based on whether the WTRUs 202a, 202b transmit large data packets or small data packets.

After the first and second resources are selected at step 210, each of the WTRUs 202a, 202b may generate control information that includes second resource selection information at step 215. The second resource selection information may include a location of the second resource such as time, frequency, location of RB, location of subcarriers, or location of PRB. After the control information is generated at step 215, each of the WTRUs 202a, 202b may transmit the control information to the BS 214 using UL NOMA on the first resource at steps 220a, 220b. It is noted that although the steps 210, 215, 235 are not illustrated for the WTRU2 202b in FIG. 2 for simplicity, the WTRU2 202b may perform the same or similar steps (i.e. steps 210, 215, 235) that are illustrated in FIG. 2.

Once the control information is received at the BS 214, the BS 214 may collect second resource information from the received control information at step 225. It is noted that the control information may be received from all WTRUs (including the WTRUs 202a, 202b) that are associated with the BS 214 in the network. The second resource information may be collected from all the control information received from all of the WTRUs. The BS 214 may then determine whether there is any overlap between the collected second resources in a time/frequency domain and/or how many second resources are overlapped in the time/frequency domain. For example, a second resource (e.g., an RB) collected from the WTRU1 202a may be overloaded with a second resource (e.g., an RB) collected from the WTRU2 202b at the same time and/or frequency. In this case, the BS 214 may determine that the second resource of the WTRU1 202a overlaps the second resource of the WTRU2 202b. The BS 214 may also determine the number of overlapped (or overloaded) second resources in all of the collected second resources. For example, if two second resources are overlapped in a time/frequency domain, the BS 214 determines that there are two users (or WTRUs) selected (or overlapped) for the resources. If a second resource is not overlapped with any other second resources, the BS 214 determines that there is only one user (or WTRU) selected for the second resource. For some second resources, the BS 214 may select only one user (or WTRU). For some second resources, the BS 214 may select more than one user (or WTRUs).

At step 227, the BS 214 may generate one or more indicators based on the overlap information (e.g., the number of overlapped second resources) to indicate whether the WTRUs 202a, 202b are to use NOMA or OMA. For example, if there is no overlap between the second resources or there is only one user (or WTRU) selected for the second resource, the one or more indicators may indicate the WTRU1 202a or the WTRU2 202b to use OMA. If there is one or more overlap between the second resources or there is more than one user (or WTRU) selected for the second resources, the one or more indicators may indicate the WTRU1 202a or the WTRU2 202b to use NOMA. Specifically, the one or more indicators may include a discontinue NOMA transmission indicator (DTI) and/or a NOMA type transmission indicator (NMI). The DTI may indicate whether the WTRUs 202a, 202b are to use NOMA or OMA for the second transmission in the second resource. The NMI may indicate a type of NOMA transmission scheme that can be used for the second transmission in the second resource.

The one or more indicators may include binary bits that can represent the DTI and/or the NMI. The NMI may be included in the DTI or exist separately. When the DTI indicates to use NOMA, the NMI may include one or more bits representing the type of NOMA transmission scheme. When the DTI indicates to use OMA, the NMI may not exist or may not include any bits to represent the type of NOMA transmission scheme. Alternatively or additionally, the NMI may include a dummy bit(s) to indicate that no NOMA transmission scheme is selected. The one or more indicators may be inserted, for example, in a field of DCI and be transmitted via a downlink control channel.

Once the one or more indicators are generated at step 227, the one or more indicators may be transmitted to the WTRU 202a at step 230a and/or to the WTRU 202b at step 230b. The one or more indicators may be transmitted jointly or individually in the same or different signaling. Upon receiving the one or more indicators, the WTRUs 202a, 202b may determine, based on the one or more indicators, whether to use NOMA or OMA and/or which type of NOMA transmission to use for the second transmission in the second resources at step 235. For example, if the DTI indicates to use OMA, the WTRU 202a may transmit data in the second resource using OMA at step 240. If the DTI indicates to use NOMA, the WTRU 202a may transmit data in the second resource using NOMA based on the NMI at step 240. The NMI may indicate or represent the type of NOMA transmission scheme. The type of NOMA transmission scheme may be determined based on the number of selected users (or WTRUs) or the number of overlapped second resources. For example, if a large number of users (or WTRUs) are selected, the WTRU 202a may use a NOMA transmission scheme such as MUSA that can deal with the large number of users (or WTRUs) at the same time. If a small number of users (or WTRUs) are selected, the WTRU 202a may use a NOMA transmission scheme such as SCMA that can accommodate the small number of users (or WTRUs) at the same time. Examples of the NOMA transmission schemes may include, but are not limited to, IDMA, IGMA, LCRS, MUSA, NCMA, NOCA, GOCA, RSMA, SCMA, and PDMA.

FIG. 3 illustrates an example overall procedure for NOMA and/or OMA transmission, which may be used in combination with any of other embodiments described herein. As illustrated in FIG. 3, a WTRU may receive NOMA resource configuration from a BS at step 305. The NOMA resource configuration may include information about resources in which the NOMA may operate such as a resource pool, time, and frequency. The WTRU may receive the NOMA resource configuration via RRC signaling if the WTRU is in connected mode or via broadcasting information if the WTRU is in idle mode. At step 310, the WTRU may autonomously select multiple resources (e.g., two resources) for UL NOMA. For example, the WTRU may select first resource for current transmission (or first transmission) and second resource for subsequent transmission (or second transmission). The WTRU may also select third, fourth, or the like resources (i.e. subsequent resources selected after the second resource) for subsequent transmission. The multiple resources selected by the WTRU may be determined based on criteria such as service types, resource partitions, priority, latency or the like.

At step 315, the WTRU may generate control information that includes resource selection information of the second resource and/or subsequence resources selected after the second resource. The resource selection information may be location information of the second or subsequent resources. Such location information may include, but are not limited to, time, frequency, location of RB, location of subcarriers, or location of PRB. The WTRU may then transmit data with the control information using UL NOMA on the first resource at step 320.

At step 345, a BS may collect the second (or subsequent) resource information from all of the WTRUs associated with the BS. At step 350, the BS may determine whether there is any overlap between the second (or subsequent) resources collected from all of the WTRUs. For example, if a second resource collected from a WTRU overlaps other second resources collected from other WTRUs, the BS may determine that there is more than one overlap between the collected second resources. The BS may determine the number of overlapped (or overloaded) second resources or the number of users (or WTRUs) that have overlapping second resources. If there is no overlap between the collected second resources, the BS may determine that there is only one user (or WTRU) for the second resource. If there is one or more overlap between the collected second resources, the BS may determine that there are more than one users (or WTRUs) for the second resources. At step 355, the BS may generate one or more indicators based on the overlapping information of the collected second resources. The one or more indicators may indicate whether the WTRU is to use NOMA or OMA, or which type of NOMA transmission is to be used. Specifically, a discontinue NOMA transmission indicator (DTI) may indicate whether the WTRU is to use NOMA or OMA, and a NOMA type transmission indicator (NMI) may indicate which type of NOMA transmission is to be used by the WTRU. For example, if there is no overlap between the collected resources, or there is only one user (or WTRU) selected for the resource, the DTI may indicate to use OMA. If there is one or more overlap between the collected resources or there is more than one user (or WTRU) selected for the collected resources, the DTI may indicate to use NOMA. In case that the DTI indicates to use NOMA, the NMI may indicate the type of NOMA transmission scheme that can be used for the subsequent transmissions in the second resource and/or subsequent resources selected after the second resource.

The one or more indicators may be binary bits or values. The bit(s) representing the DTI and the bit(s) representing the NMI may exist together or separately. In case that the DTI indicates to use NOMA, the NMI may include one or more bits representing the type of NOMA transmission scheme together with the DTI or separately from the DTI. In case that the DTI indicates to use OMA, the NMI may not include any bits to represent the type of NOMA transmission scheme or include a dummy bit(s) to indicate that no NOMA transmission scheme is selected. The DTI and the NMI may be inserted, for example, in a field of downlink control information (DCI) and be transmitted via a downlink control channel.

Once the BS generates one or more indicators, the BS may transmit the one or more indicators to the WTRU at step 355 and the WTRU may receive the one or more indicators at step 325. The WTRU may determine, based on the one or more indicators, whether to use NOMA or OMA, and/or which type of NOMA transmission to use for the second transmission in the second resources or for the subsequent transmissions in the resources selected after the first resource. For example, if the DTI indicates to use OMA at step 330, the WTRU may transmit data in the second resource using OMA at step 340. If the DTI indicates to use NOMA at step 330, the WTRU may transmit data in the second resource using NOMA based on the NMI at step 335. The NMI may indicate the type of NOMA transmission scheme that is determined based on the number of selected users (or WTRUs) or the number of overlapped second resources. As described above, examples of the NOMA transmission schemes may include, but are not limited to, IDMA, IGMA, LCRS, MUSA, NCMA, NOCA, GOCA, RSMA, SCMA, and PDMA.

FIG. 4 illustrates an example WTRU transmit processing 400 for Non-Orthogonal Multiple Access (NOMA), which may be used in combination with any of other embodiments described herein. At step 405, a WTRU may select two resources: the first resource(s) for current transmission and the second resource(s) for subsequent transmissions. At step 410, the WTRU may generate control information which includes the information about the second resource that is selected by the WTRU for subsequent UL NOMA transmissions. Upon generating the control information, at step 415, the WTRU may transmit data with the generated control information using UL NOMA in the first resource that is selected. The control information may include the information about the second resource that is selected by the WTRU.

FIG. 5 illustrates an example gNB processing 500 for NOMA, which may be used in combination with any of other embodiments described herein. At step 505, a gNB may receive data and control information from all WTRUs based on configured resources for the first resource. At step 510, the gNB may then process the data and collect the control information from all the WTRUs regarding the second resource(s). At step 515, the gNB may then generate a union of the second resources reported from all the WTRUs. At step 520, one or more indicators including a DTI and a NMI may be transmitted to a WTRU via downlink control channel, for example, common control channel or group common control channel GC-PDCCH. The DTI and the NMI may be determined based on overlapping information of the union of second resources from all the WTRUs.

FIG. 6 illustrates an example gNB processing for hybrid NOMA and/or OMA, which may be used in combination with any of other embodiments described herein. Similar to FIG. 5, at step 605, a gNB may receive data and control information from all WTRUs based on configured resources for the first resource. At step 610, the gNB may then process the data and collect the control information from all the WTRUs regarding the second resource(s). At step 615, the gNB may generate a union of the second resources reported from all the WTRUs. At step 640, a DTI indicator that indicates the union of second resources from all WTRUs may be transmitted to WTRUs via a downlink control channel, for example, GC-PDCCH.

In addition, at step 620, if the second resources overlap for some WTRUs, a UL NMI indicator may be utilized to capture those resources that are overlapped. If the second resources overlap for some WTRUs, the NMI indicator may be transmitted to WTRUs at step 625, for example, via GC-PDCCH. If the second resources do not overlap for all the WTRUs, the NMI indicator may not be transmitted at step 630.

In some embodiments, the URLLC may or may not use NOMA. A UL pre-emption indicator may be used to indicate UL URLLC resources. Additionally or alternatively, a UL NOMA indicator may be used to indicate which resources within indicated UL URLLC resources may use NOMA or OMA.

FIG. 7 illustrates an example WTRU receive processing 700 for NOMA, which may be used in combination with any of other embodiments described herein. At step 705, a WTRU may receive one or more indicators, for example, via a downlink control channel, a common control channel, or a group common control channel (e.g., GC-PDCCH). The WTRU may or may not receive the NMI indicator. If the WTRU receives the NMI indicator, the WTRU may process the NMI indicator at step 710 and check the resources indicated in the received NMI indicator.

At step 720, if the WTRU is configured to transmit data in some resource indicated in the NMI indicator, the WTRU may continue the transmission on its own second resource using NOMA at step 725. The WTRU may continue the transmission on resources not indicated in the NMI indicator using OMA at step 730. If the WTRU is not configured to transmit data in the resource indicated in the NMI indicator, the WTRU may discontinue the transmission on all resource indicated in the NMI indicator at step 735. The WTRU may continue the transmission on resource not indicated in the NMI indicator using OMA at step 740.

FIG. 8 illustrates another example WTRU receive processing 800 for NOMA, which may be used in combination with any of other embodiments described herein. At step 805, a WTRU may receive one or more indicators, for example, via a downlink control channel, a common control channel, or a group common control channel (e.g., GC-PDCCH). The WTRU may or may not receive the DTI indicator. If the WTRU receives the DTI indicator, the WTRU may process the DTI indicator at step 810 and check the resources indicated in the received DTI indicator.

At step 815, if the WTRU is configured to transmit data in some resource indicated in the DTI indicator, the WTRU may continue the transmission on its own second resource using NOMA at step 820. The WTRU may continue the transmission on resource not indicated in the DTI indicator at step 830. At step 815, if the WTRU is not configured to transmit data in the resource indicated in the DTI indicator, the WTRU may discontinue the transmission on all resource indicated in the DTI indicator at step 835. The WTRU may continue the transmission on resource not indicated in the DTI indicator at step 840.

FIG. 9 illustrates an example WTRU receive processing 900 for hybrid NOMA and/or OMA, which may be used in combination with any of other embodiments described herein. At step 905, a WTRU may receive one or more indicators, for example, via a downlink control channel, a common control channel, or a group common control channel (e.g., GC-PDCCH). The WTRU may or may not receive the DTI indicator. If the WTRU receives the DTI indicator, the WTRU may process the DTI indicator at step 910 and check the resources indicated in the received DTI indicator.

At step 915, if the WTRU is configured to transmit data in some resource indicated in the DTI indicator, the WTRU may continue the transmission on its own second resource using either OMA or NOMA at step 920. The WTRU may further check if an NMI indicator is received or not at step 925. If an NMI indicator is detected by the WTRU at step 925, the WTRU may continue the transmission on its own second resource indicated in the NMI indicator using NOMA at step 930. The WTRU may continue the transmission on resources not indicated in the DTI indicator at step 935. If an NMI indicator is not detected by the WTRU at step 925, the WTRU may continue the transmission on its own second resource indicated in the NMI indicator using OMA at step 940. The WTRU may continue the transmission on resource not indicated in the DTI indicator at step 945

At step 915, if the WTRU is not configured to transmit data in the resource indicated in the DTI indicator, the WTRU may discontinue the transmission on all resource indicated in the DTI indicator at step 950. The WTRU may continue the transmission on resource not indicated in the DTI indicator at step 955.

FIG. 10 illustrates an example WTRU receive processing 1000 for NOMA and/or OMA, which may be used in combination with any of other embodiments described herein. At step 1005, a WTRU may receive one or more indicators, for example, via GC-PDCCH. The WTRU may or may not receive the DTI indicator. If the WTRU receives the DTI indicator, the WTRU may process the DTI indicator at step 1010 and check the resources indicated in the received DTI indicator.

At step 1015, if the WTRU is configured to transmit data in some resource indicated in the DTI indicator, the WTRU may continue the transmission on its own second resource using NOMA at step 1020. The WTRU may continue the transmission on resource not indicated in the DTI indicator using OMA at step 1025. At step 1015, if the WTRU is not configured to transmit data in the resource indicated in the DTI indicator, the WTRU may continue the transmission on the resource indicated in the NMI indicator using NOMA at step 1030 within the resources indicated in the DTI indicator. The NMI Indicator may override the DTI indicator such that the WTRU may still continue the transmission in the resources indicated in the DTI indicator. The WTRU may continue the transmission on resource not indicated in the DTI indicator using OMA at step 1035.

The WTRU may discontinue the transmission on other resources indicated in the DTI indicator but not indicated in the NMI Indicator. The WTRU may continue the transmission on resource not indicated in the DTI indicator using OMA.

In some embodiments, the URLLC may or may not use NOMA with eMBB. A DTI indicator may be used to indicate UL URLLC resources. Additionally or alternatively, a NMI indicator may be used to indicate which resources within indicated UL URLLC resources in the DTI may use NOMA, for example, with eMBB.

A Downlink Control Information (DCI) format may be used for the DTI for notifying Physical Resource Block(s) (PRB(s)) and Orthogonal Frequency Division Multiplexing (OFDM) symbol(s) where a WTRU may assume no transmission at the WTRU. The DCI format may be used for an NMI for notifying the PRB(s) and OFDM symbol(s) where the WTRU may assume NOMA transmission at the WTRU.

The following information for the DTI may be transmitted by means of the DCI format: an identifier for DCI formats—J1 bits; and a DTI indication 1, a DTI indication 2, . . . , a DTI indication N1. The following information for an NMI may be transmitted by means of the DCI format: an identifier for DCI formats—J2 bits; and an NMI indication 1, an NMI indication 2, . . . , an NMI indication N2.

The size of DCI format may be configurable by higher layers. Each DTI or NMI indication may be M1 or M2 bits. For example, the M1 or M2 bits may be 14 bits. The J1 or J2 may be 1 bit or 2 bits.

Service, data type and use case-dependent NOMA and/or OMA are described herein. A WTRU may be configured with resources (e.g., a single resource or multiple resources) for the URLLC. The WTRU may use some indication for a discontinuous transmission indication (DTI). The WTRU may be configured with periodicity and offset for resource(s). The term resource may refer to one or more elements from a time, frequency, and/or spatial domain.

For DL, the URLLC may use those configured resource(s). However, the URLLC may not be present in every configured resource. The presence and absence of the URLLC may be indicated using a preemption indication to indicate which resource may be present or absent for the URLLC. A WTRU may check the preemption indication and figure out if URLLC data is present or not. If it is present, eMBB data may rate match around the resource that is configured for the URLLC. The preemption indication may include the indication for PRB(s) and OFDM symbols(s) for the URLLC. For the WTRUs performing eMBB, those WTRUs may just puncture the URLLC data when decoding the eMBB data. For the WTRUs performing eMBB and being configured with URLLC, the WTRUs may rate match around the URLLC data when decoding the eMBB data.

FIG. 11 illustrates an example orthogonal multiple access (OMA) 1100, which may be used in combination with any of other embodiments described herein. As illustrated in FIG. 11, data of different types may be transmitted from same or different WTRUs 1102a, 1102b, 1102c, 1102d. Data type 1 1105 and data type 2 1110 may be transmitted from the same or different WTRUs 1102a, 1102b, 1102c, 1102d. For example, the data type 1 1105 may be eMBB and the data type 2 1110 may be URLLC. Resource allocation for the data type 1 1105 may be via DCI or a Medium Access Control Control Element (MAC CE). Resource allocation for the data type 2 1110 may be via RRC or a MAC CE. The data type 1 1105 may be scheduled by grant. The data type 2 1110 may be either grant-based, grant-free or hybrid grant-free and grant-based. If it is grant-based, the WTRUs 1102a, 1102b, 1102c, 1102d may be informed of other parameters other than the resource allocation for data transmission. If it is grant-free-based, the WTRUs 1102a, 1102b, 1102c, 1102d may autonomously transmit data without grant. If it is hybrid-based, the WTRUs 1102a, 1102b, 1102c, 1102d may autonomously transmit data if the WTRUs 1102a, 1102b, 1102c, 1102d do not receive grant and may transmit data based on grant if the WTRUs 1102a, 1102b, 1102c, 1102d receive the grant.

In an embodiment, WTRUs that are not configured with the data type 2 may have special handling of the resources configured for the data type 2. Two scenarios may be described: in the scenario 1, a WTRU may receive an indicator (e.g., UL preemption indicator) to inform the WTRU which resources the WTRU may not use for the transmission of data type 1; and in the scenario 2: a WTRU may receive another indicator (e.g., UL NOMA indicator) to inform the WTRU which resources the WTRU may use for the transmission of data type 1 via NOMA.

In the scenario 2, the WTRU may use NOMA for the data type 1 transmission in those resources configured for the data type 2. The WTRU may use NOMA for the data type 2 1110 transmission in those resources configured for the data type 2.

Whether to use the scenarios 1 or 2 may depend on use case and may be configured or indicated by a BS (e.g., gNB). For example, the scenario 1 may be used if the data type 1 is eMBB and the data type 2 is URLLC. The scenario 2 may be used if the data type 1 is eMBB and the data type 2 is mMTC. The network may configure or indicate which embodiment may be used by the WTRU.

In RRC connected mode, a WTRU may receive an indicator (e.g., UL preemption indicator) to inform the WTRU which resources the WTRU should not use for the transmission of data type 1, or receive another indicator (e.g., UL NOMA indicator) to inform the WTRU which resources the WTRU may use for the transmission of data type 1 by NOMA via the following methods or combination of them: WTRU-specific RRC signaling; a WTRU-specific MAC CE; a WTRU-specific PDCCH; a Common PDCCH; and a Group common PDCCH. In RRC connected mode, resource configuration for the data type 2 may be via RRC or a MAC CE.

In idle mode, a WTRU may receive an indicator (e.g., UL preemption indicator) to inform the WTRU which resources the WTRU may not use for the transmission of data type 1, or receive another indicator (e.g., UL NOMA indicator) to inform the WTRU which resources the WTRU may use for the transmission of data type 1 by NOMA via the following methods or combination of them: a NR-PBCH; remaining minimum system information (RMSI); other system information (OSI); a random access response (RAR); a RACH message 4; a group common PDCCH; and paging. In idle mode, resource configuration for data type 2 may be via RMSI and/or OSI.

For UL, for example, the data type 2 may be URLLC. The URLLC may use those configured resource(s). However, the URLLC may not be present in every configured UL resource. The presence and absence of the URLLC may be indicated using a UL preemption indication to indicate which UL resource may be present or absent for the URLLC. All WTRUs may check the UL preemption indication and figure out if URLLC data are present or not. If it is present, eMBB data may discontinue the transmission in the resources that are indicated for the URLLC. The UL preemption indication may include the indication for PRB(s) and OFDM symbols(s) for the URLLC.

When a WTRU receives an UL preemption indication, for the WTRU who has the data type 1 (e.g., eMBB), the WTRU may discontinue the transmission in those resources indicated for URLLC data in UL preemption indication among resources configured for the URLLC when transmitting eMBB data. The WTRU may perform the following: (1) transmit eMBB data in the resources indicated in the UL grant but not configured for the URLLC; (2) continue the eMBB transmission in the resources not indicated for URLLC data in the UL preemption indication among resources configured for the URLLC; and (3) discontinue the eMBB transmission in the resources indicated for URLLC data in the UL preemption indication among resources configured for the URLLC.

For a WTRU performing eMBB and being configured with URLLC, the WTRU may perform the following: transmit URLLC data in the configured URLLC resource; transmit eMBB data in the resources indicated in UL grant but not configured for the URLLC; continue the eMBB transmission in the resources not indicated for URLLC data in the UL preemption indication among resources configured for the URLLC; and discontinue the eMBB transmission in the resources indicated for URLLC data in the UL preemption indication among resources configured for the URLLC.

When a WTRU receives an UL NOMA indication, for the WTRU who has the data type 1 (e.g., eMBB), the WTRU may continue the transmission using NOMA in those resources for URLLC data indicated in the UL NOMA indication. The WTRU may perform the following: (1) transmit eMBB data in the resources indicated in UL grant but not configured for the URLLC; (2) continue the eMBB transmission in the resources indicated for URLLC data in the UL NOMA indication among resources configured for the URLLC; and (3) discontinue the eMBB transmission in the resources not indicated for URLLC data in the UL NOMA indication among resources configured for the URLLC.

For a WTRU performing eMBB and being configured with URLLC, the WTRU may transmit URLLC data in the configured URLLC resource and continue to transmit eMBB data in the resources indicated in UL grant but not configured for the URLLC and continue the transmission in the resources indicated for URLLC data in the UL NOMA indication. The WTRU may perform the following: (1) transmit URLLC data in the configured URLLC resource; (2) transmit eMBB data in the resources indicated in UL grant but not configured for the URLLC; (3) continue the eMBB transmission in the resources indicated for URLLC data in the UL NOMA indication among resources configured for the URLLC; and (4) discontinue the eMBB transmission in the resources not indicated for URLLC data in the UL NOMA indication among resources configured for the URLLC.

When a WTRU receives both an UL preemption indication and an UL NOMA indication, for the WTRU who has data type 1 (e.g., eMBB), those WTRUs may discontinue the transmission in those resources indicated for URLLC data in the UL preemption indication among resources configured for the URLLC but continue the transmission in those resources indicated for URLLC data in the UL NOMA indication among resources configured for the URLLC when transmitting the eMBB data. The WTRU may perform the following: (1) transmit the eMBB data in the resources indicated in UL grant but not configured for the URLLC; (2) continue the eMBB transmission in the resources indicated for URLLC data in the UL NOMA indication among resources configured for the URLLC; and (3) discontinue the eMBB transmission in the resources indicated for URLLC data in the UL preemption indication among resources configured for the URLLC. When the WTRU decides to continue or discontinue the transmission for eMBB in URLLC resources, the UL NOMA indication may override the UL preemption indication.

Embodiments for supporting URLLC OMA/NOMA operation may include the following procedures. First, a WTRU may transmit type 1 data in resources not configured for type 2 data. Second, a WTRU may receive an indicator, for example, UL preemption indicator. The WTRU may continue the transmission of data type 1 in resources configured for data type 2 if the resources are not indicated for use by data type 2 in the UL preemption indicator. The WTRU may continue the transmission of data type 1 using OMA. Third, if NOMA is configured, the WTRU may receive another indicator, for example, an UL NOMA indicator. The WTRU may continue the transmission of data type 1 in resources configured for data type 2 if the resources are indicated for use by data types 1 & 2 in the UL NOMA indicator. The WTRU may continue the transmission of data type 1 using NOMA. The UL NOMA indicator may be a full set of indicators similar to the UL preemption indicator or a subset of the UL preemption indicator. The UL NOMA indicator may override the UL preemption indicator. Lastly, if NOMA is configured, a WTRU may discontinue the transmission of data type 1 in resources configured for data type 2 if the resources are indicated for use by data type 2 in the UL preemption indicator but not indicated for use by data types 1 and 2 in the UL NOMA indicator. The WTRU may discontinue the transmission of data type 1 completely.

Embodiments for supporting URLLC OMA and mMTC NOMA operations may include the following procedures. First, a WTRU may transmit type 1 data in resources not configured for type 2 data. Second, the WTRU may receive an indicator, for example, an UL preemption indicator. The WTRU may continue the transmission of data type 1 in resources configured for data type 2 if the resources are not indicated for use by data type 2 in the UL preemption indicator. The WTRU may continue the transmission of data type 1 using OMA. Third, if NOMA is configured, the WTRU may receive another indicator, for example, an UL NOMA indicator. The WTRU may continue the transmission of data type 1 in resources configured for data type 2 if the resources are indicated for use by data types 1 and 2 in the UL NOMA indicator. The WTRU may continue the transmission of data type 1 using NOMA. The UL NOMA indicator may be a full set of indicators similar to the UL preemption indicator or a subset of UL preemption indicator. The UL NOMA indicator may override the UL preemption indicator. Lastly, if NOMA is configured, the WTRU may discontinue the transmission of data type 1 in resources configured for data type 2 if the resources are indicated for use by data type 2 in the UL preemption indicator but not indicated for use by data types 1 and 2 in the UL NOMA indicator. The WTRU may discontinue the transmission of data type 1 completely.

FIG. 12 illustrates an example joint OMA and NOMA 1200, which may be used in combination with any of other embodiments described herein. Data type 1 1205, type 2 1210 and type 3 1215 may be transmitted from same or different WTRUs 1202a, 1202b, 1202c, 1202d. For example, the data type 1 1205 may be eMBB, data type 2 1210 may be URLLC and data type 3 1215 may be mMTC. Resource allocation for data type 1 1205 may be via a DCI or a MAC CE. Resource allocation for data type 2 1210 and data type 3 1215 may be via RRC or a MAC CE. Data type 1 1205 may be scheduled by grant. Data type 2 1210 and data type 3 1215 may be either grant-based or grant-free. If it is grant-based, the WTRU 1202a, 1202b, 1202c, 1202d may be informed of other parameters other than resource allocation. If grant-free, the WTRUs 1202a, 1202b, 1202c, 1202d may autonomously send data without grant.

In an embodiment, WTRUs that are not configured with data types 2 and 3 may have special handling of the resources configured for data types 2 and 3. Two scenarios may be described: in scenario 1, a WTRU may receive an indicator (e.g., UL preemption indicator) to inform the WTRU which resources the WTRU should not use for the data transmission of type 1; and in the scenario 2, the WTRU may receive another indicator (e.g., UL NOMA indicator) to inform the WTRU which resources the WTRU may use for data transmission of type 1.

In scenario 2, the WTRU may use NOMA for data type 1 transmission in those resources configured for type 2 and 3 data. The WTRU may use OMA for data type 2 transmission in those resources configured for type 2 data. The WTRU may use NOMA for data type 3 transmission in those resources configured for type 3 data.

Whether to use scenarios 1 or 2 may depend on use case. For example, scenario 1 may be used if data type 1 is eMBB and data type 2 is the URLLC. Scenario 2 may be used if data type 1 is eMBB and data type 3 is mMTC. The network may configure or indicate which scenario may be used by the WTRU.

In UL URLLC, a WTRU may transmit URLLC data randomly, and select the resource randomly. A BS (e.g., gNB) may need to blindly decode the URLLC. One example may be to use a URLLC transmission indication in UL. The URLLC transmission indication may be embedded in UL. The URLLC transmission indication may be: (1) carried in UL URLLC data; (2) carried in UL MAC CE; (3) embedded in resource, for example, in a fixed position of URLLC resource that is configured; and (4) carried in UL grant such as DCI.

A NOMA resource may be configured for a WTRU. A combination of OMA and NOMA resource may be configured for the WTRU. The WTRU may be configured with the following for the URLLC: a OMA resource; a NOMA resource; and the combination of OMA and NOMA resources.

The OMA and NOMA resources may be configured with different periodicities and/or offset. If a WTRU is configured with the OMA resource for the URLLC, such a WTRU can access the OMA resource. If a WTRU is configured with the NOMA resource for the URLLC, such a WTRU can access the NOMA resource. If a WTRU is configured with both OMA and NOMA resources for the URLLC, such a WTRU can access both OMA and NOMA resources.

The criteria for a WTRU to access both OMA and NOMA resources when both are configured may be priority of the URLLC, WTRU class, WTRU capability, randomness, or the like.

FIG. 13 illustrates an example NOMA, which may be used in combination with any of other embodiments described herein. Data type 1 1300 and data type 3 1310 may be transmitted from same or different WTRUs 1302. Data type 1 1305 may be eMBB and data type 3 1310 may be the URLLC. Resource allocation for data type 1 1305 may be via DCI or a MAC CE. Resource allocation for data type 3 1310 may be via RRC or a MAC CE. Data type 1 1305 may be scheduled by grant. Data type 3 1310 may be grant-free. The WTRUs 1302 may autonomously send data without grant. Resources for data type 3 1310 may be shared (via NOMA) by all of the WTRUs 1302 of data type 3 1310.

In an embodiment, WTRUs that are not configured with data type 3 may have special handling of the resources configured for data type 3. Two scenarios may be described as follows: in scenario 1, a WTRU may receive an indicator (e.g., UL preemption indicator) to inform the WTRU which resources the WTRU should not use for data transmission of type 1; and in scenario 2, a WTRU may receive another indicator (e.g., UL NOMA indicator) to inform the WTRU which resources the WTRU may use for data transmission of type 1.

In scenario 2, the WTRU may use NOMA for data type 1 transmission in those resources configured for type 3 data. The WTRU may use NOMA for data type 3 transmission in those resources configured for type 3 data.

Whether to use scenarios 1 or 2 may depend on use case. For example, the scenario 1 may be used if data type 1 is eMBB and data type 3 is the URLLC. The scenario 2 may be used if data type 1 is eMBB and data type 3 is mMTC. The network may configure or indicate which scenario may be used by the WTRU.

A WTRU may be configured in different groups. Each group may be configured with a NOMA resource with same or different periodicities and offsets. The NOMA resource may include following multiple types: a type A NOMA resource that supports mMTC; a type B NOMA resource that supports only URLLC; a type C NOMA resource that supports both mMTC and URLLC; a type D NOMA resource that supports both eMBB and URLLC; and a type ENOMA resource that supports all eMBB, URLLC and mMTC.

Efficient joint NOMA operations are described herein. First, pre-configured resources with a maximum number of WTRUs are described herein. Since NOMA may degrade or even break down due to too many WTRUs sharing the same resource, the number of WTRUs may be limited for a given resource. For example, resource(s) may be pre-configured. Alternatively or additionally, the maximum number of WTRUs may be pre-configured per resource. The pre-configuration of the maximum number of WTRUs per resource may be determined based on an overload factor and may depend on the NOMA scheme.

The maximum number of WTRUs for each configured resource may be uniform, same or different. Once the maximum number of WTRUs for each configured resource is configured, a BS (e.g., gNB) may also indicate the signature for each configured resource. Such indication may be semi-static, dynamic or derived based on a formula.

For the maximum capacity N to be supported in a system where an overloading factor is Q (can support Q WTRUs simultaneously in the same resource), and M=N/Q resources may be required. For each resource, the Q signature may be indicated to the Q WTRUs. The WTRU may be indicated the following: resource(s) or resource partition(s) that the WTRU may be scheduled; a signature that the WTRU may be assigned; and a reference signal (RS) that the WTRU may be assigned.

If a WTRU activity can be known or predicted, the above example can achieve the most efficiency. The WTRU activity may be predicted based on the historical behavior or latest activity or the like. If a WTRU activity cannot be known or predicted, a virtual overloading factor may be determined as QQ (can support Q WTRUs simultaneously in the same resource assuming QQ WTRUs in the same resource). If the WTRU activity factor is y %, the QQ=Q×100/y. If actual number of the WTRU is greater than Q for a given resource, then collision of RS and/or signature may occur.

Collision handling may be described herein. Collision may occur in two dimensions: RS domain; and signature domain. The RS over-dimensioning may be referred to as a scenario 1. This scenario 1 may be to over-dimension the RS capacity while maintaining the same signature capacity. If signature collision occurs, the network can rely on the RS to distinguish a WTRU.

For the WTRUs sharing the same signature but different RSs, channel characteristic may be used to distinguish or identify WTRU data. If it is under low channel correlation, a WTRU can be identified or distinguished. If it is under high channel correlation, a WTRU can be identified or distinguished with degradation or may not be identified. Retransmission or repetition may be needed if necessary. Scenario 1 may use many RSs mapping to one signature.

Signature over-dimensioning may be referred to as scenario 2. Specifically, this scenario 2 may be to over-dimension the signature capacity while maintaining the same RS capacity. If RS collision occurs, the network can rely on the signature to distinguish a WTRU.

For the WTRUs sharing the same RS but different signatures, channel characteristic may not be able to be used to distinguish or identify WTRU data. Instead, a signature may be used to identify the WTRU. If it is under high power difference, the WTRU with high power can be identified or distinguished based on the RS since the other WTRU's channel response may be considered as interference or noise. Once high power WTRU's channel is estimated, they can be removed, and a clean RS can be used to estimate the other WTRU's channel response, and so on. If it is under equal power condition, the WTRU may still be identified or distinguished with different signature but with degradation, or may not be identified at all. Retransmission, repetition and power difference increase or power control may be needed. Scenario 2 may use many signatures mapping to one RS.

Over-dimensioning of both RS and signature may be referred to as scenario 3. This scenario 3 may increase both RS and signature capacity to reduce the collision, mitigate or avoid collision. However, the resource utilization efficiency may be relatively lower as compared to above scenarios 1 and 2. This may be suitable for high requirement service or high end WTRUs.

The network may indicate or configure the scenario to a WTRU as a function of service type, service requirement, WTRU capability, or the like. Such indication or configuration may be static, semi-static, dynamic, or the like.

The network may indicate or configure the following scenarios to a WTRU as a function of service type, service requirement, WTRU capability: NOMA scenario 1; NOMA scenario 2; NOMA scenario 3; and OMA.

NOMA transmission occasion is described herein. The NOMA occasion may be defined as the time and/or frequency where a WTRU may access NOMA resource and transmit data using NOMA operation. NOMA occasion may be defined by at least one of time index, frequency index, WTRU ID, or the like.

A common NOMA occasion may be defined by time (e.g., time duration, periodicity, time offset, or the like) and frequency (e.g., resource size, frequency index, frequency offset, or the like). A WTRU-specific NOMA occasion may be a function of WTRU ID. The time index may be an OFDM symbol index, a mini-slot index, a non-slot index, a slot index, a subframe index, a frame index or the like. The frequency index may be a subcarrier or subcarrier group index, a resource block (RB) index, a resource block group (RBG) index, a resource element group (REG) index, a sub-band index, a bandwidth part (BWP) index, a carrier index, or the like.

NOMA density control is described herein. The network may configure a WTRU to different NOMA resources. For example, the resource (e.g., RRC, MAC CE, DCI, or the like) may be indicated explicitly. The resource may also be indicated implicitly (e.g., based on a rule, a set of rules, derived from other condition(s), parameter(s), or the like).

The network may configure different density for NOMA operation by some parameters such as Mod (WTRU ID, N), where N may be configured by a BS (e.g., gNB). The WTRU ID may be C-RNTI, TC-RNTI, IMSI, or the like.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
determining a first resource and a second resource for uplink (UL) non-orthogonal multiple access (NOMA), wherein the first resource is associated with first transmission and the second resource is associated with second transmission;
generating control information that includes selection information of the second resource;
transmitting, to a base station (BS), the control information using the UL NOMA on the first resource as the first transmission; and
receiving, from the BS, one or more indicators indicating whether the second transmission uses the UL NOMA or orthogonal multiple access (OMA) on the second resource.

2. The method of claim 1, wherein the one or more indicators comprise a discontinue NOMA transmission indicator (DTI) and a NOMA type transmission indicator (NMI).

3. The method of claim 2, wherein the NMI indicates a type of NOMA transmission based on a multiple access signature.

4. The method of claim 2, further comprising:
on a condition that the DTI indicates to use the OMA, transmitting data on the second resource using the OMA as the second transmission.

5. The method of claim 2, further comprising:
on a condition that the DTI indicates to use the UL NOMA, transmitting, based on the NMI, data on the second resource using the UL NOMA as the second transmission.

6. The method of claim 1, further comprising:
receiving, from the BS, a NOMA resource configuration that includes time and frequency resources for the UL NOMA.

7. The method of claim 1, wherein the selection information includes a location of the second resource in the UL NOMA resource configuration.

8. The method of claim 1, wherein the first resource and the second resource are determined based on at least one of a service type, a resource partition, a priority of traffic, or a latency of traffic.

9. The method of claim 8, wherein the service type includes an enhanced mobile broadband (eMBB), massive machine type communications (mMTC), and ultra reliable and low latency communications (URLLC).

10. The method of claim 1, further comprising:
receiving, via a downlink control channel, downlink control information (DCI) that includes the one or more indicators.

11. A wireless transmit/receive unit (WTRU) comprising:
a processor configured to:
determine a first resource and a second resource for uplink (UL) non-orthogonal multiple access (NOMA), wherein the first resource is associated with first transmission and the second resource is associated with second transmission; and
generate control information that includes selection information of the second resource;
a transmitter configured to transmit, to a base station (BS), the control information using the UL NOMA on the first resource as the first transmission; and
a receiver configured to receive, from the BS, one or more indicators indicating whether the second transmission uses the UL NOMA or orthogonal multiple access (OMA) on the second resource.

12. The WTRU of claim 11, wherein the one or more indicators comprise a discontinue NOMA transmission indicator (DTI) and a NOMA type transmission indicator (NMI).

13. The WTRU of claim 12, wherein the NMI indicates a type of NOMA transmission based on a multiple access signature.

14. The WTRU of claim 12, wherein the transmitter is further configured to, on a condition that the DTI indicates to use the OMA, transmit data on the second resource using the OMA as the second transmission.

15. The WTRU of claim 12, wherein the transmitter is further configured to, on a condition that the DTI indicates to use the UL NOMA, transmit, based on the NMI, data on the second resource using the UL NOMA as the second transmission.

16. The WTRU of claim 11, wherein the receiver is further configured to receive, from the BS, a NOMA resource configuration that includes time and frequency resources for the UL NOMA.

17. The WTRU of claim 11, wherein the selection information includes a location of the second resource in the UL NOMA resource configuration.

18. The WTRU of claim 11, wherein the first resource and the second resource are determined based on at least one of a service type, a resource partition, a priority of traffic, or a latency of traffic.

19. The WTRU of claim 18, wherein the service type includes an enhanced mobile broadband (eMBB), massive machine type communications (mMTC), and ultra reliable and low latency communications (URLLC).

20. The WTRU of claim 11, wherein the receiver is further configured to receive, via a downlink control channel, downlink control information (DCI) that includes the one or more indicators.
